(19) United States
(12) Patent Application Publication
(10) Pub. No.: US 2021/0272139 A1
(43) Pub. Date: Sep. 2, 2021

(54) INFORMATION PROCESSING APPARATUS, INFORMATION PROCESSING METHOD, AND PROGRAM

(71) Applicant: SONY CORPORATION, TOKYO (JP)

(72) Inventors: TAKAO TAJIRI, TOKYO (JP); EIJIRO MORI, TOKYO (JP)

(21) Appl. No.: 17/250,292

(22) PCT Filed: Dec. 27, 2018
(86) PCT No.: PCT/JP2018/048103

§ 371 Date: Dec. 28, 2020

Related U.S. Application Data
(60) Provisional application No. 62/694,203, filed on Jul. 5, 2018.

(51) Int. Cl. G06Q 30/02; G06Q 10/10

(52) U.S. Cl. CPC G06Q 30/0201; G06Q 10/1053; G06Q 30/0202

(57) ABSTRACT

[Object] To objectively indicate market prices of human resources and promote fair market competition. [Solving Means] Provided is an information processing apparatus including a supply-and-demand information generating unit that generates supply-and-demand information indicating supply and demand of a first user who desires provision of a human resource and a second user who desires provision of remuneration as price for the provision of the human resource, in which the supply-and-demand information generating unit generates the supply-and-demand information for each skill set between possessed skill information of the first user and desired skill information of the second user.

### TECHNICAL FIELD

The present disclosure relates to an information processing apparatus, an information processing method, and a program.

### BACKGROUND ART

Efficient acquisition of human resources is very important in the operation of organizations such as companies. It is also important for a user who provides the human resource to find an organization that presents remuneration or the like that more matches the desired condition. A system described in Patent Literature 1, for example, is cited as a mechanism for supporting matching between them.

### CITATION LIST

### Patent Literature

Patent Literature 1: Japanese Patent Application Laid-open No. 2003-256551

### DISCLOSURE OF INVENTION

### Technical Problem

However, in the system described in Patent Literature 1, the supply and demand of the recruiting side and the recruited side are not considered. Therefore, in the system described in Patent Literature 1, it is difficult for a user on the recruited side to objectively determine his/her own value in the market, and it is difficult for a user on the recruiting side to set appropriate remuneration according to the market price.

### Solution to Problem

In accordance with the present disclosure, there is provided an information processing apparatus, including: a supply-and-demand information generating unit that generates supply-and-demand information indicating supply and demand of a first user who desires provision of a human resource and a second user who desires provision of remuneration as price for the provision of the human resource, in which the supply-and-demand information generating unit generates the supply-and-demand information for each skill set between possessed skill information of the first user and desired skill information of the second user.

Further, in accordance with the present disclosure, there is provided an information processing method including generating, by a processor, supply-and-demand information indicating supply and demand of a first user who desires provision of a human resource and a second user who desires provision of remuneration as price for the provision of the human resource, in which the generating the supply-and-demand information includes generating the supply-and-demand information for each skill set between possessed skill information of the first user and desired skill information of the second user.

Further, in accordance with the present disclosure, there is provided a program that causes a computer to function as an information processing apparatus including a supply-and-demand information generating unit that generates supply-and-demand information indicating supply and demand of a first user who desires provision of a human resource and a second user who desires provision of remuneration as price for the provision of the human resource, in which the supply-and-demand information generating unit generates the supply-and-demand information for each skill set between possessed skill information of the first user and desired skill information of the second user.

### BRIEF DESCRIPTION OF DRAWINGS

FIG. 1 A display example of supply-and-demand information generated by a supply-and-demand information generating unit according to an embodiment of the present disclosure.

FIG. 2 A block diagram showing a system configuration example according to the embodiment and a functional configuration example of an information processing server.

FIG. 3 A diagram showing an example of an information registration screen of a first user according to the embodiment.

FIG. 4 A diagram showing an example of a category input screen according to the embodiment.

FIG. 5 A diagram showing an example of a skill input screen according to the embodiment.

FIG. 6 A diagram for describing automatic registration of possessed skill information based on content according to the embodiment.

FIG. 7 A diagram showing an example of a screen for displaying a portfolio of the first user according to the embodiment.

FIG. 8 A diagram showing an example of a screen for displaying details of past contract conclusion information associated with the first user according to the embodiment.

FIG. 9 A diagram for describing skill acquisition suggestion to the first user according to the embodiment.

FIG. 10 A diagram showing an example of a search screen of a buy order according to the embodiment.

FIG. 11 An example showing a search result screen of the buy order according to the embodiment.

FIG. 12 A diagram showing an example of a registration screen of the buy order according to the embodiment.

FIG. 13 An example of a screen showing detailed information of the buy order according to the embodiment.

FIG. 14 A diagram for describing chat control between the first user and a second user by a display control unit according to the embodiment.

FIG. 15 A diagram for describing the display of a remuneration amount associated with another user under contract negotiation according to the embodiment.

FIG. 16 A diagram for describing automatic generation of a plurality of pieces of buy order information by an order information generating unit according to the embodiment.

FIG. 17 A flowchart showing a flow of processing of an information processing system according to the embodiment.

FIG. 18 A diagram showing an example of a hardware configuration of an information processing server according to an embodiment of the present disclosure.

### MODE(S) FOR CARRYING OUT THE INVENTION

Favorable embodiments of the present disclosure will be described in detail with reference to the accompanying drawings. It should be noted that in the present specification and drawings, components having substantially the same functional configurations will be denoted by the same reference signs and overlap descriptions thereof will be omitted.

It should be noted that the descriptions will be given in the following order.
1. Embodiment
1.1. Overview
1.2. System Configuration Example
1.3. Details of Functions
1.4. Flow of Processing
2. Hardware Configuration Example
3. Conclusion

### 1. Embodiment

«1.1. Overview»

First, the overview of an embodiment of the present disclosure will be described. In recent years, it is urgently necessary for companies and the like to secure excellent human resources, and it is also important for users on a recruited side to efficiently find recruitment that matches their own desired conditions.

For this reason, in recent years, many services have been developed to support matching between the recruiting side and the recruited side. For example, a company or the like serving as the recruiting side can disclose job offers or the like including remuneration or the like on the service as described above, and a user serving as the recruited side can apply for job offers or the like matching the conditions on the service.

In this way, in accordance with such a service, both the recruiting side and the recruited side can easily search for the matching partner, and the process up to the contract can be made more efficient.

In the current state, however, the supply-and-demand balance of human resources is not sufficiently considered in many services. For example, in the service as described above, the recruiting side can set a skill set required on the recruited side, but it is difficult to grasp how many human resources having the skill set exist in the market. For this reason, in many cases, the recruiting side sets the remuneration on the basis of the final educational background and the like, but it is difficult to say that such remuneration setting sufficiently reflects the market price (scarcity) of the above-mentioned skill set, and this is a factor causing the wage reduction and the like.

Further, in the service as described above, it is difficult for the recruited side to grasp how many competitors having a skill set equivalent to his/her skill set exist in the market. For this reason, it is difficult for many of the users on the recruited side to objectively appeal their scarcity to the recruiting side, and they cannot sufficiently negotiate the remuneration amount presented by the recruiting side.

Moreover, since people are reskilled (grow) through learning and experience, even the same person can always change his/her value. Therefore, it is necessary to more accurately grasp the supply and demand of human resources as compared with the supply and demand of general goods.

The technical idea according to the embodiment of the present disclosure has been conceived by focusing on the above-mentioned points and makes it possible to objectively indicate market prices of human resources and promote fair market competition.

To this end, an information processing server 20 according to an embodiment of the present disclosure includes a supply-and-demand information generating unit 230 that generates supply-and-demand information indicating supply and demand of a first user who desires provision of a human resource and a second user who desires provision of remuneration as price for the provision of the human resource. The supply-and-demand information generating unit 230 according to the embodiment of the present disclosure is characterized by generating the supply-and-demand information for each skill set that matches between possessed skill information of the first user and desired skill information of the second user.

Here, the first user may be, for example, a user on the recruited side as described above and the second user may be, for example, a company or the like on the recruiting side. That is, the first user according to this embodiment is a user who desires to provide labor to the second user under an employment contract or labor contract and the second user according to this embodiment may be a user who desires to provide remuneration for labor provided under the same contract.

On the other hand, the type of the contract between the first user and the second user according to this embodiment is not limited to the above example, and the contract concluded between the first user and the second user may be, for example, a contract for work, a contract of mandate, a contract for entrustment, or the like. Also, the remuneration in this embodiment is understood to broadly include salary, pay, wage, and the like.

That is, the first user according to this embodiment broadly includes a person who desires to provide a human resource or deliverables etc. created by the human resource to the second user and the second user according to this embodiment broadly includes a person who desires to pay remuneration as the price for the provision of the human resource etc. by the first user.

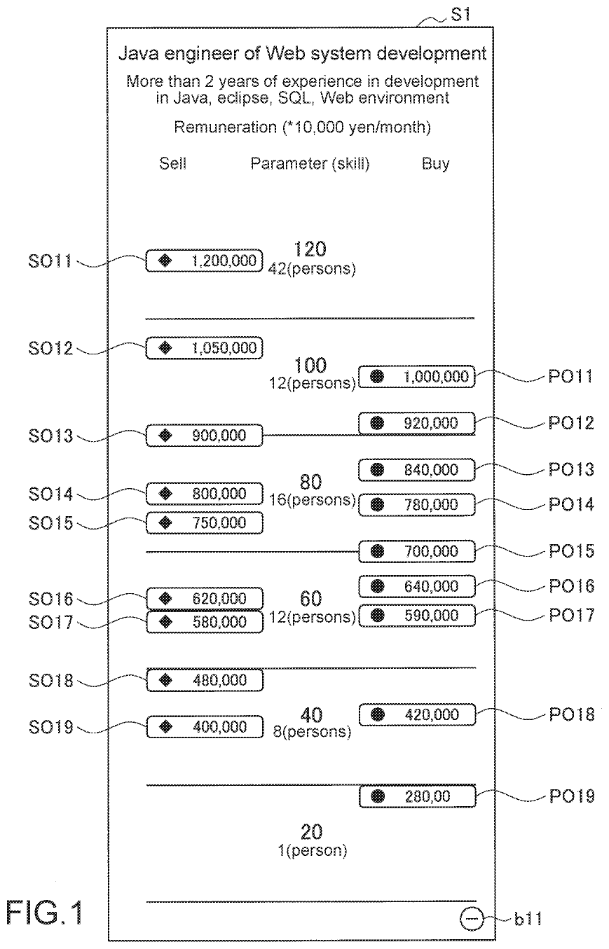

FIG. 1 is a display example of the supply-and-demand information generated by the supply-and-demand information generating unit 230 according to this embodiment. In the case of the example shown in FIG. 1, the supply-and-demand information generating unit 230 generates, on the basis of the desired skill information input by the second user and the possessed skill information input by the first user, the supply-and-demand information related to a skill set common to both.

In the example shown in FIG. 1, the skill set common to both may be “Java (registered trademark) engineer of Web system development” and “more than 2 years of experience in development in the Java, eclipse, SQL, Web environment for”.

That is, the supply-and-demand information shown in FIG. 1 objectively indicates how many second users recruiting the “Java engineer of Web system development” with “more than 2 years of experience in development in the Java, eclipse, SQL, Web environment” (demand) exist in the market and how many first users corresponding to the “Java engineer of Web system development” with “more than 2 years of experience in development in the Java, eclipse, SQL, Web environment” (supply) exist in the market.

As described above, in accordance with the supply-and-demand information generated by the supply-and-demand information generating unit 230 according to this embodiment, it is possible to objectively and dynamically grasp the supply-and-demand situation for each skill set.

The supply-and-demand information generating unit 230 according to this embodiment may generate the above-mentioned supply-and-demand information also on the basis of a desired remuneration amount input by the first user and a paid remuneration amount input by the second user. The supply-and-demand information generated by the supply-and-demand information generating unit 230 according to this embodiment may include a distribution of desired remuneration amounts and paid remuneration amounts as described above.

For example, in the case of the example shown in FIG. 1, a display control unit 240 of the information processing server 20 according to this embodiment displays the supply-and-demand information generated by the supply-and-demand information generating unit 230 on a screen S1 using a board representation. In other words, in this embodiment, the first user's desire to provide human resources is regarded as a sell order and the second user's recruitment of human resources is regarded as a buy order, and the orders can be displayed as a sell board and a buy board like financial products.

For example, in FIG. 1, a distribution of sell orders SO11 to SO19 by a plurality of first users is shown on the basis of a desired remuneration amount input by each of the first users. Similarly, a distribution of buy orders PO11 to PO19 by a plurality of second users is shown on the basis of a paid remuneration amount input by each of the second users.

In accordance with the display of the supply-and-demand information as described above according to this embodiment, both the first user and the second user can intuitively and clearly grasp the market price of the corresponding skill set.

For example, in the case of the example shown in FIG. 1, the sell order SO11 in which the desired remuneration amount is 1,200,000 yen exists while the largest value of the paid remuneration amount of the buy order PO is 1,000,000 yen. Therefore, the first user who has made the sell order SO11 can increase the possibility of getting a contract by grasping that the desired remuneration amount input by himself does not match that in the market and modifying the desired remuneration amount in accordance with the distribution of the buy orders PO11 to PO19.

Further, for example, in the case of the example shown in FIG. 1, the buy order PO19 in which the paid remuneration amount is 280,000 yen exists while the smallest value of the desired remuneration amount of the sell order SO is 400,000 yen.

Also, in the case of the example shown in FIG. 1, the parameter of the first user having the corresponding skill set is shown separately from the sell order SO. For example, when the remuneration amount is 1,100,000 or more, the parameter is 42, which indicates that there are 42 first users having the corresponding skill set and setting the desired remuneration amount to 1,100,000 yen or more. On the other hand, since the sell order SO for which the desired remuneration amount is set to 1,100,000 yen or more is only one sell order SO11, it is understood that only one of 42 persons has actually made the sell order SO.

On the other hand, in a case where the remuneration amount is 300,000 yen or less, it is extremely unlikely that the sell order SO will be made in the same amount range in the future because the parameter itself is 0. Therefore, the second user who has made the buy order PO19 can increase the possibility of acquiring human resources by grasping that the set paid remuneration amount does not match that in the market and modifying the paid remuneration amount in accordance with the distribution of the sell orders SO11 to SO19.

The display example of the supply-and-demand information according to this embodiment has been described above. As described above, in accordance with the information processing server 20 according to this embodiment, the supply and demand of human resources are objectively indicated for each skill set and both the first user and the second user can clearly grasp the market price of the skill set. In accordance with such a function, it is possible to give both the users an opportunity to review the setting of the remuneration amount and promote fair market competition.

«1.2. System Configuration Example»

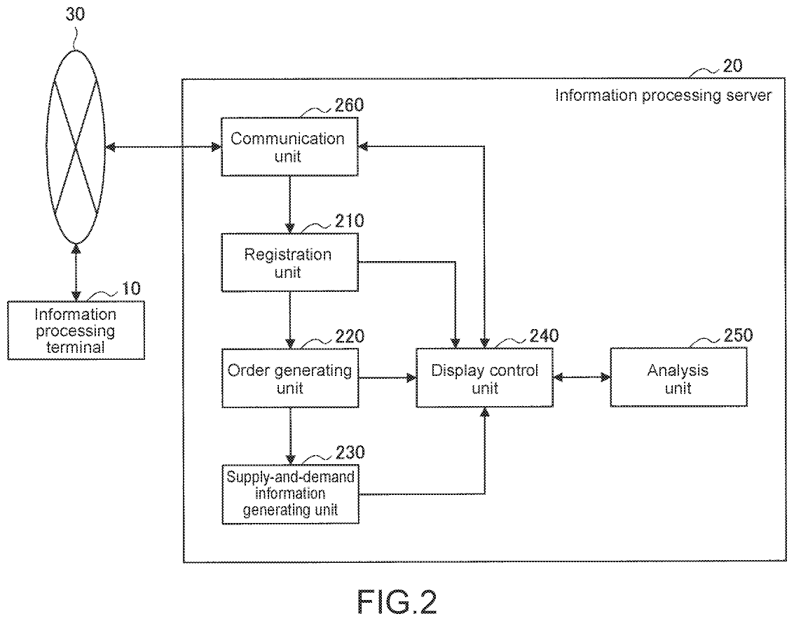

Next, a configuration example of the information processing system according to this embodiment will be described. FIG. 2 is a block diagram showing an example of a system configuration example and a functional configuration example of the information processing server 20 according to this embodiment. As shown in FIG. 2, the information processing system according to this embodiment includes an information processing terminal 10 and the information processing server 20. Further, the information processing terminal 10 and the information processing server 20 are connected via a network 30 so as to be communicable with each other.

(Information Processing Terminal 10)

The information processing terminal 10 according to this embodiment is an information processing apparatus used by the first user and the second user for inputting and browsing information. The display control unit 240 according to this embodiment controls a user interface that the first user or the second user accesses through the information processing terminal 10.

The information processing terminal 10 according to this embodiment may be, for example, a personal computer (PC), a smart phone, a tablet, or the like.

(Information Processing Server 20)

The information processing server 20 according to this embodiment is an information processing apparatus that generates supply-and-demand information relating to human resources for each skill set and controls the display of the supply-and-demand information.

(Network 30)

The network 30 has a function of connecting the information processing terminal 10 and the information processing server 20. The network 30 may include a public network such as the Internet, a telephone line network, a satellite communication network, a variety of local area networks (LANs) including Ethernet (registered trademarks), a variety of wide area networks (WANs), and the like. The network 30 may also include a dedicated line network such as an internet protocol-virtual private network (IP-VPN). The network 30 may also include a radio communication network such as Wi-Fi (registered trademark) and Bluetooth (registered trademark).

The configuration example of the information processing system according to this embodiment has been described above. It should be noted that the configuration described above with reference to FIG. 2 is merely an example, and the configuration of the information processing system according to this embodiment is not limited to this example. The configuration of the information processing system according to this embodiment can be flexibly modified in accordance with specifications and operations.

Next, a functional configuration example of the information processing server 20 according to this embodiment will be described. As shown in FIG. 2, the information processing server 20 according to this embodiment includes a registration unit 210, an order information generating unit 220, the supply-and-demand information generating unit 230, the display control unit 240, an analysis unit 250, and a communication unit 260.

(Registration Unit 210)

The registration unit 210 according to this embodiment registers user information, skill information, a remuneration amount, and the like on the basis of input information received from the information processing terminal 10. For example, the registration unit 210 according to this embodiment registers the possessed skill information associated with the first user on the basis of the information input by the first user. Further, for example, the registration unit 210 registers the desired skill information associated with the second user on the basis of the information input by the first user.

Furthermore, the registration unit 210 according to this embodiment may have a function of automatically generating the possessed skill information associated with the first user on the basis of content uploaded by the first user. Details of this function will be described later.

(Order Information Generating Unit 220)

The order information generating unit 220 according to this embodiment generates sell order information associated with the provision of the human resources and buy order information associated with the provision of the remuneration. The order information generating unit 220 may generate sell order information corresponding to the sell order SO on the basis of the possessed skill information of the first user and the desired remuneration amount registered by the registration unit 210. Further, the order information generating unit 220 may generate buy order information corresponding to the buy order PO on the basis of the desired skill information of the second user and the paid remuneration amount.

(Supply-and-Demand Information Generating Unit 230)

The supply-and-demand information generating unit 230 according to this embodiment generates supply-and-demand information indicating supply and demand between the first user and the second user. At this time, one of the features of the supply-and-demand information generating unit 230 according to this embodiment is to generate supply-and-demand information for each skill set that matches between the possessed skill information of the first user and the desired skill information of the second user.

Specifically, the supply-and-demand information generating unit 230 according to this embodiment may generate supply-and-demand information including a distribution of the sell order information and the buy order information generated by the order information generating unit 220 for each skill set. Further, the supply-and-demand information generating unit 230 according to this embodiment is capable of dynamically generating supply-and-demand information on the basis of a search condition input by the first user or the second user.

(Display Control Unit 240)

The display control unit 240 according to this embodiment controls the display of the supply-and-demand information generated by the supply-and-demand information generating unit 230. For example, as described above, the display control unit 240 according to this embodiment displays the supply-and-demand information on the user interface using the board representation.

(Analysis Unit 250)

The analysis unit 250 according to this embodiment performs analysis using various types of information received or generated by the information processing server 20. The analysis unit 250 according to this embodiment may perform causal analysis associated with the first user or the second user on the basis of information collected at the time of conclusion of a contract, during the contract period, at the time of the contract, and the like, for example.

(Communication Unit 260)

The communication unit 260 according to this embodiment performs information communication with the information processing terminal 10 via the network 30. For example, the communication unit 260 receives various types of information input by the first user or the second user from the information processing terminal 10. Further, for example, the communication unit 260 transmits a control signal of the user interface generated by the display control unit 240 to the information processing terminal 10.

As described above, a functional configuration example of the information processing server 20 according to this embodiment has been described. The above-mentioned configuration described with reference to FIG. 2 is merely an example and the functional configuration of the information processing server 20 according to this embodiment is not limited to this example. For example, the information processing server 20 may further have a configuration other than the configuration described above or the configuration described above may be implemented in a distributed manner by a plurality of apparatuses. The functional configuration of the information processing server 20 according to this embodiment can be flexibly modified in accordance with specifications and operations.

«1.3. Details of Functions»

Next, functions of the information processing server 20 according to this embodiment will be described in detail. It should be noted that an example will be described hereinafter in which the information processing server 20 according to this embodiment controls a Web service for supporting matching between the first user according to this embodiment, who is a job seeker who desires employment by an organization such as a company, and the second user, who desires employment of a human resource that matches the condition.

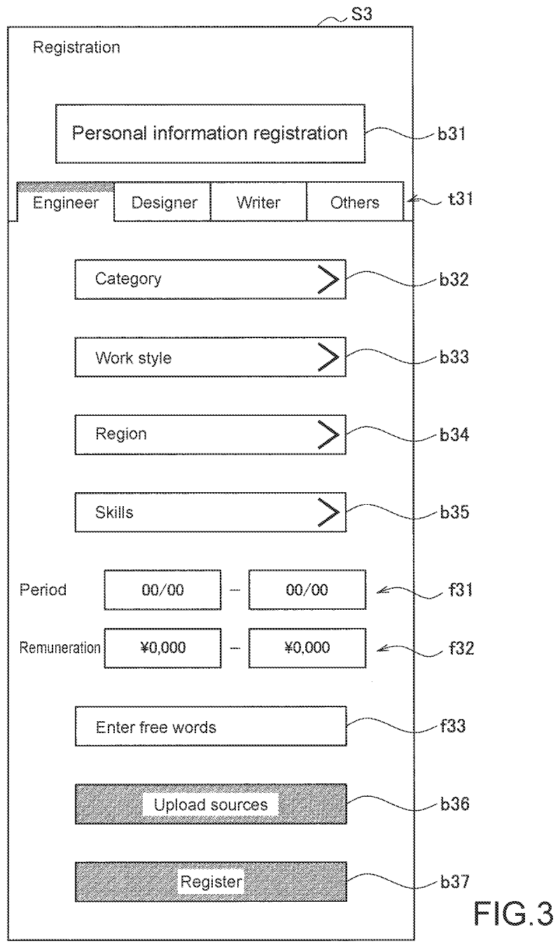

First, a flow of information registration by the first user according to this embodiment will be described. FIG. 3 is a diagram showing an example of an information registration screen of the first user according to this embodiment. The display control unit 240 according to this embodiment may display a screen S3 as shown in the figure on the user interface through which the first user accesses the information processing terminal 10.

The first user can register information about himself/herself by performing various operations on the screen S1. For example, the first user may register personal information by operating a button b31. In this case, the button b31 functions as a link to a screen for inputting personal information such as a name.

Further, the first user may be able to select a job type by operating a tab t31. In this case, the tab t31 controls switching of input items set for each job type.

The first user inputs various types of information by operating buttons b32 to b35 and the like. The button b32 may be a link to a screen for inputting a category of a job type.

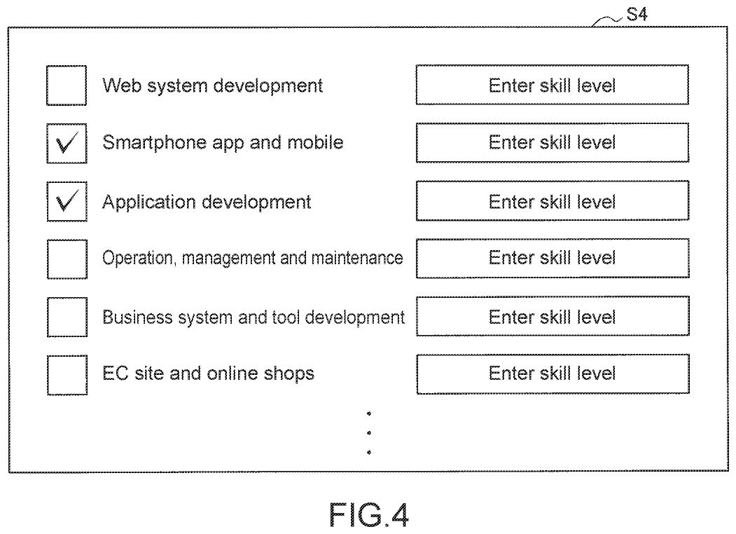

FIG. 4 is a diagram showing an example of a category input screen according to this embodiment. The category according to this embodiment is an item for further subdividing the job type. For example, in a case where the job type is an engineer (IT), it is Web system development, smartphone application and mobile application development, operation, management and maintenance, and business system. Categories such as tool development, EC site and online shops, and the like may be selectable.

In this case, the first user according to this embodiment may be able to select a category according to his/her own experience and input a skill level according to his/her experience (e.g., senior level, staff level, etc.) on the screen S4. Further, the user can input, for example, years of experience, roles (e.g., project manager, unit leader, etc.), types of experienced projects (including industry, etc.), sizes, and the like. It should be noted that the job type and category input as described above may be treated as a part of the possessed skill information according to this embodiment.

The description will be continued again with reference to FIG. 3. The button b33 may be a link to a screen for inputting a desired work style. Examples of the work style include on-site work, remote work, and the like.

Further, the button b34 may be a link to a screen for selecting a desired work place. For example, in a case where the remote work is selected as the work style, the first user may be able to select a country or region on a global scale rather than just a domestic region. In accordance with the Web service realized by the information processing server 20 according to this embodiment, it is also possible to perform matching on the basis of the supply and demand of human resources on the global scale.

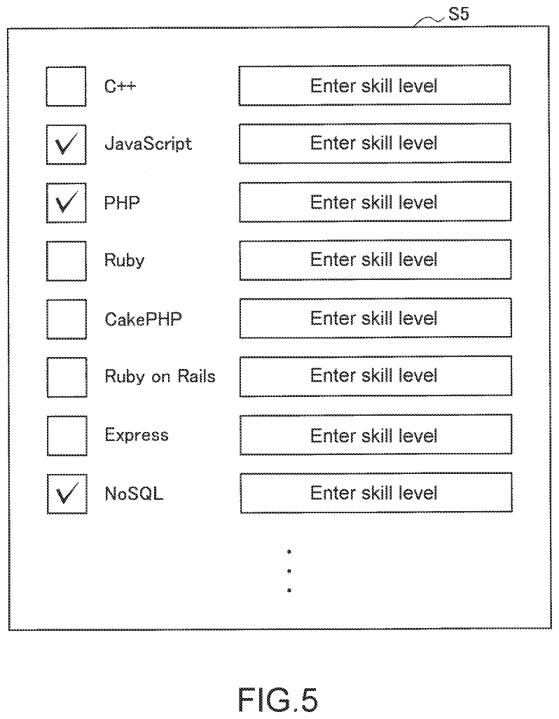

Further, the button b35 may be a link to a screen for inputting possessed skills. FIG. 5 is a diagram showing an example of a skill input screen according to this embodiment. FIG. 5 shows a screen S5 in a case where the job type is an engineer (IT).

In this case, the first user can select, for example, a programming language and the like that can be used by the first user on the screen S5. Also, as in the case of the category, the first user may be able to input the skill level.

The description will be continued again with reference to FIG. 3. A field f31 is a field for setting a desired work time and a field f32 is a field for inputting a desired remuneration amount. Unlike typical services, in this embodiment, the first user can register the sell order SO by specifying an arbitrary period and an arbitrary desired remuneration amount. With this configuration, it is possible to realize flexible and high-precision matching in a timely manner even in an industry in which the supply and demand change rapidly. It should be noted that a field f33 may be a field in which the first user can freely register a keyword and the like relating to items other than those described above.

Further, a button b36 may be a link to a screen for the first user to upload content according to the job type. The registration unit 210 according to this embodiment is also capable of automatically generating the possessed skill information associated with the first user on the basis of the content uploaded by the first user.

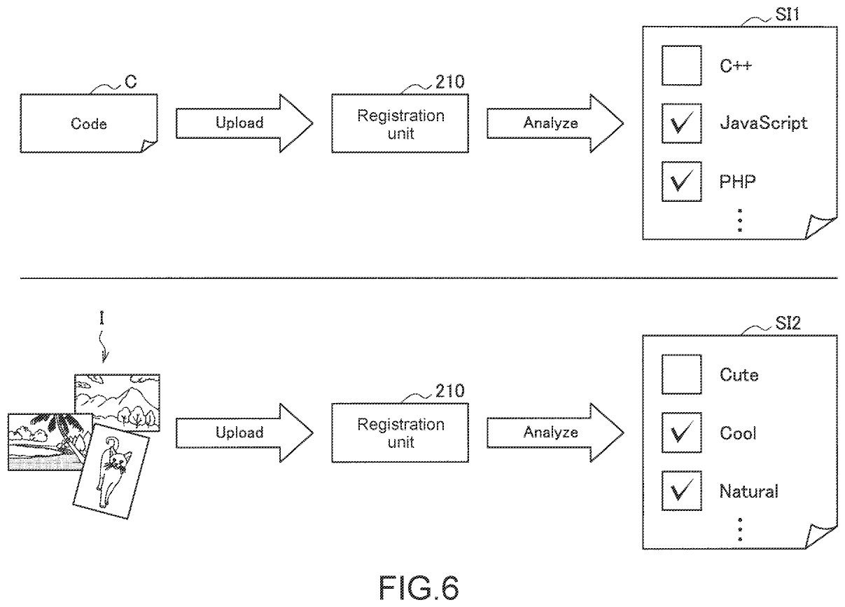

FIG. 6 is a diagram for describing automatic registration of possessed skill information based on content according to this embodiment. For example, in the upper part of FIG. 6, an example in a case where the job type of the first user is an engineer (IT) is shown.

In this case, the registration unit 210 according to this embodiment is capable of specifying the programming language used for the source code C by analyzing the source code C created and uploaded by the first user. Further, the registration unit 210 according to this embodiment may acquire information regarding the number of steps and the like and the quality by analyzing the source code C. The registration unit 210 according to this embodiment is capable of automatically registering possessed skill information SI1 as shown in the figure on the basis of the analysis result as described above.

Further, in the lower part of FIG. 6, an example in a case where the job type of the first user is a designer is shown. In this case, the first user uploads pictures, photographs, and other images I related to the design as the content created by the first user. At this time, the registration unit 210 according to this embodiment analyzes the images I using, for example, a machine-learning algorithm or the like, and determines the style of the images I, that is, the first user's artistic style (e.g., cute, cool, natural, or the like). Further, the registration unit 210 is capable of automatically registering possessed skill information SI2 as shown in the figure on the basis of the determination result.

It should be noted that the registration unit 210 is capable of performing determination as described above by using a determiner generated by teacher learning or the like in advance.

As described above, the registration unit 210 according to this embodiment is capable of automatically registering the possessed skill information on the basis of not only the source code but also various types of content created by the first user. Examples of the content include, for example, audio data recording voices in a case where the job type is a singer, a voice actor, an announcer, a chair, or the like, and video data recording dance performances in a case where the job type is a dancer.

It should be noted that the registration unit 210 according to this embodiment may perform automatic registration of the possessed skill information as described above on the basis of content uploaded to another Web service or the like. For example, in a case where there is a Web service for storing and disclosing the source code created by the engineer, the registration unit 210 in this embodiment may analyze the source code acquired in cooperation with the Web service.

The flow of the information registration of the first user and the screen example according to this embodiment have been described above. The first user according to this embodiment can register his/her own information by pressing a button b37 shown in FIG. 3 after inputting various types of information as described above. It should be noted that the information registration by pressing the button b37 is distinguished from the registration of the sell order SO. The first user according to this embodiment can register the sell order SO at an arbitrary time after registering his/her own information. The registration of the sell order SO according to this embodiment will be described later.

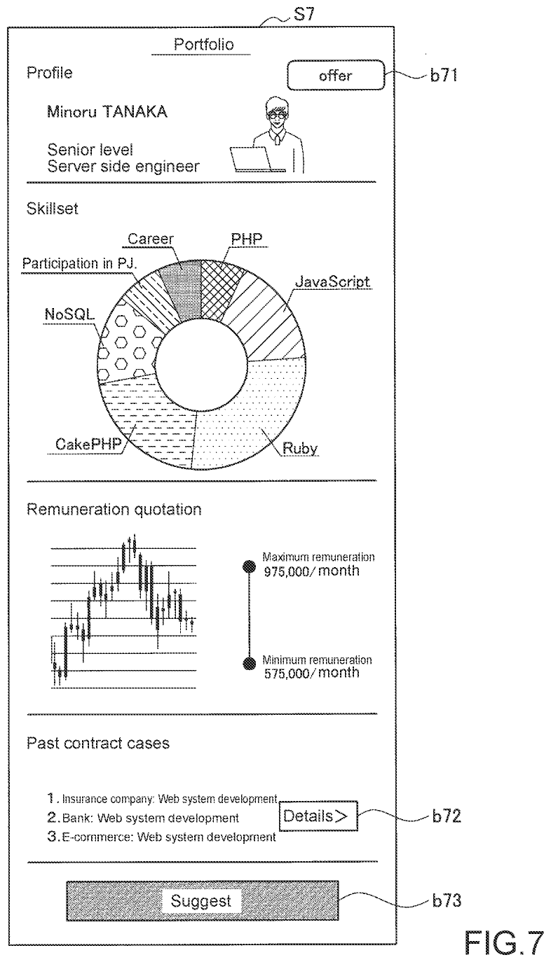

Next, a display example of the portfolio of the first user according to this embodiment will be described. FIG. 7 is a diagram showing an example of a screen for displaying the portfolio of the first user according to this embodiment. The display control unit 240 according to this embodiment is capable of summarizing and displaying the portfolio of the first user as a screen S7 as shown in the figure, on the basis of information such as registration information, sell orders SO, and contract conclusion information associated with the first user, and other sell orders SO or buy orders PO having a common skill set. The screen S7 may be a screen that can be viewed by the second user in addition to the corresponding first user.

The second user may be able to check the screen S7 as detailed information by selecting the sell order SO registered by the first user, for example. The screen S7 according to this embodiment displays, for example, the profile and the possessed skill set of the first user. The display control unit 240 is capable of displaying the profile and the skill set on the screen S7 on the basis of the personal information and the possessed skill information input by the first user. Information

Further, the display control unit 240 according to this embodiment may control the display of remuneration quotation information corresponding to the possessed skill set of the first user on the basis of the supply-and-demand information based on the sell orders SO and the buy orders PO registered in the past, contract achievements, and the like. For example, in the case of the example shown in FIG. 7, the display control unit 240 displays the maximum remuneration amount and the minimum remuneration amount in time series on the basis of past contract achievements of other first users having a skill set equivalent to that of the first user who is a target. Such remuneration quotation information is one type of information indicating the supply and demand associated with the first user and the second user.

In this manner, the display control unit 240 according to this embodiment is capable of causing a transition of the supply and demand associated with the first user and the second user to be displayed in time series for each skill set on the basis of the supply-and-demand information and the contract conclusion information such as the contract achievements. It should be noted that the display control unit 240 may cause the number of registrations of the sell order SO, the buy order PO, and the like to be displayed in times series instead of the remuneration quotation.

The display control unit 240 according to this embodiment may cause a prediction of the supply and demand associated with the first user and the second user predicted by the analysis unit 250 to be displayed for each skill set. The analysis unit 250 according to this embodiment may perform supply-and-demand prediction using a well-known estimation technique.

In accordance with the display as described above, the first user or the second user can grasp the transition of the market price of the corresponding skill set from the viewpoint of the past, present, and future, and can appropriately set the remuneration. It should be noted that the transition of the supply and demand as described above may be able to be checked from other than the screen S7.

Further, the display control unit 240 according to this embodiment may display, on the screen S7, information regarding past contract cases of the corresponding first user. In the case of the example shown in FIG. 7, the display control unit 240 displays information of three cases (buy orders PO) in which the first user concluded the contract with the second user in the past.

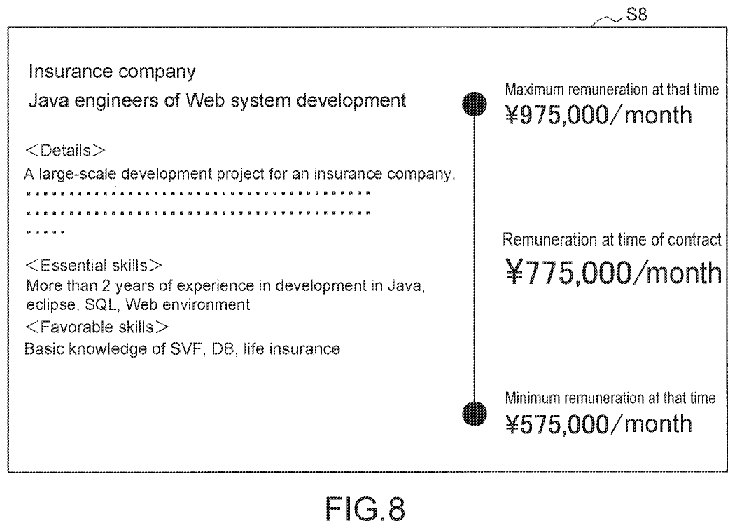

At this time, the first user and the second user may be able to check the details of each case by pressing a button b72, for example. FIG. 8 is a diagram showing an example of a screen for displaying details of past contract conclusion information associated with the first user according to this embodiment.

In the case of the example shown in FIG. 8, the display control unit 240 displays on a screen S8 information regarding the buy orders PO in which the first user has concluded the contract, and further displays a contract remuneration amount and the remuneration quotation at the time of the contract. In this example, it is shown that the first user has concluded the contract at the contract remuneration amount ¥775,000 for the buy order PO registered by the second user in the past, and that the maximum remuneration amount of the human resource (other first user) having a skill set equivalent to that of the first user at the time of the contract was ¥975,000 and the minimum remuneration amount was ¥575,000.

In this manner, the display control unit 240 according to this embodiment is capable of controlling the display of the contract conclusion information including the contract remuneration amount information and the remuneration quotation information at the time of the contract. In accordance with such control, the second user who has checked the above-mentioned information can objectively grasp the value of the first user in the past market. With this configuration, the second user can set an appropriate paid remuneration amount in consideration of the appropriateness and the like of the remuneration in the previous job of the first user.

It should be noted that in a case where the second user checks the information to be checked shown in FIG. 7 or FIG. 8 and determines that the condition desired by the first user is met, the second user may be able to negotiate with the first user by pressing a button b71 shown in FIG. 7, for example. The negotiation on the contract according to this embodiment will be described later.

Further, the display control unit 240 according to this embodiment may control the display of the remuneration quotation information in a case where the first user acquires further skills. For example, the first user can check the remuneration quotation information by pressing a button b73 on the screen S7 shown in FIG. 7.

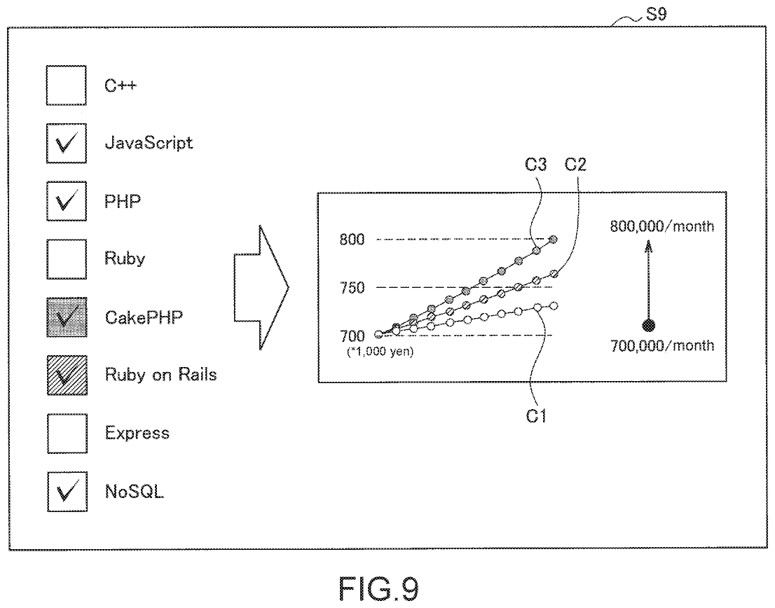

FIG. 9 is a diagram for describing skill acquisition suggestion to the first user according to this embodiment. In the case of the example shown in FIG. 9, the display control unit 240 according to this embodiment displays various types of skill information on the left side of a screen S9 and market information including curves C1 to C3 corresponding to the quotation corresponding to the skill set on the right side.

Here, it is assumed that the possessed skill set of the first user at present is JavaScript (registered trademark), PHP, and NoSQL. Further, the curve C1 corresponds to the quotation corresponding to the possessed skill.

On the other hand, Ruby on Rails and CakePHP are skills that the first user does not have at present. At this time, the display control unit 240 may display quotation information when the first user acquires those skills as the curves C2 and C3. It should be noted that in the case of the example shown in FIG. 9, the display control unit 240 associates each skill with each curve by the same hatching.

In accordance with the above-mentioned control, the first user can intuitively and clearly grasp how much his/her market price, and thus his/her remuneration, increases when he/she acquires the suggested skill, and can use it as an index of self-training.

The registration and display of the information associated with the first user have been described above. Next, search for the buy order PO and registration of the sell order SO by the first user according to this embodiment will be described.

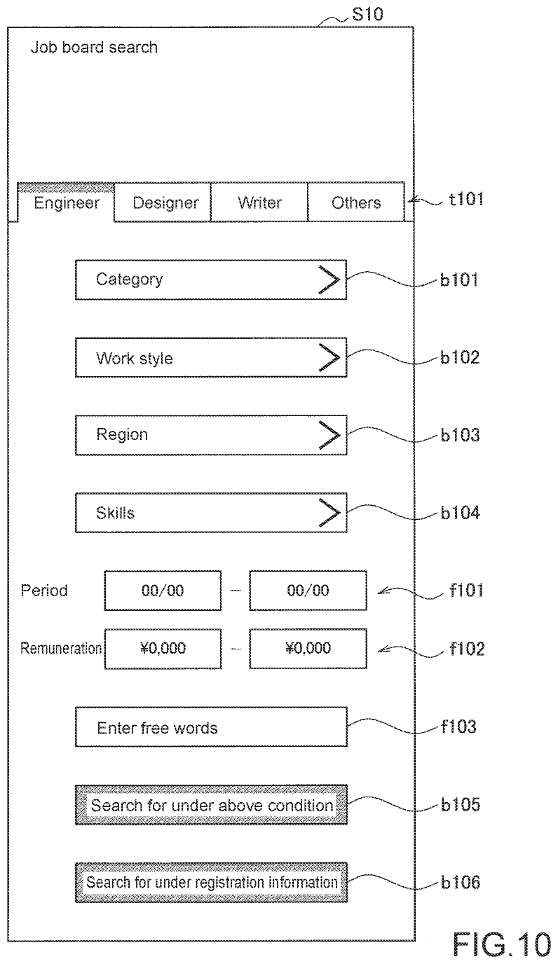

FIG. 10 is a diagram showing an example of a search screen of the buy order PO according to this embodiment. The first user or the second user can input various types of information and press the buttons b105 on a screen S10 as shown in the figure, for example, to thereby search for buy orders PO based on the input condition. Further, the first user may perform a search based on the information registered on the screen 3 shown in FIG. 3 by pressing a button b106.

It should be noted that a tab t101, buttons b101 to b104, and fields f101 to f103 on the screen S10 may have functions equivalent to those of the tab t31, the buttons b32 to b35, and the fields f31 to f33 shown in FIG. 3, and thus detailed descriptions thereof are omitted.

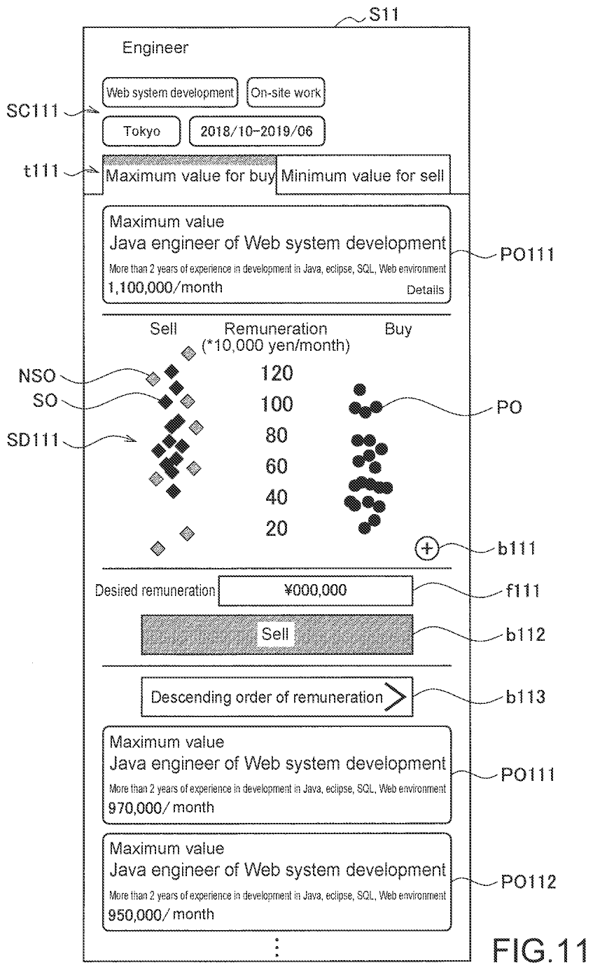

FIG. 11 is an example showing a search result screen of the buy order PO according to this embodiment. On a screen S11 shown as an example in FIG. 11, a skill condition SC111 used as the search condition is displayed at the top of the screen. Further, the tab till has a function of switching the display of the maximum value (maximum paid remuneration amount) of the buy order PO and the display of the minimum value (minimum paid remuneration amount) of the sell order SO that matches the skill condition SC111.

Further, in the middle part of the screen S11, supply-and-demand information SD111 indicating a distribution of set remuneration amounts (desired remuneration amount or paid remuneration amount) of all the sell orders SO and the buy orders PO that match the skill condition SC111 is shown.

The first user and the second user can intuitively grasp the market quotation corresponding to the skill condition SC111 by checking the supply-and-demand information SD111 as shown in the figure.

Further, a non-selling user NSU included in the supply-and-demand information SD111 indicates a first user who has the skill set matching the skill condition SC111 and who has not registered the sell order SO. In accordance with such display, it is possible to grasp how many first users having the skill set matching the skill condition SC111 exist in the market, and it is possible to predict the possibility that the sell order SO will be registered in the future.

It should be noted that the first user and the second user may be able to switch the display to the display of the supply-and-demand information using the board representation as illustrated in FIG. 1 by pressing a button bill arranged below the supply-and-demand information SD111. Further, the first user and the second user may be able to return to the screen S11 shown in FIG. 11 by pressing a button b11 arranged on the screen S1 shown in FIG. 1.

As shown in the lower part of the screen S11, the overview of each buy order PO may be displayed in a list format. Further, the display may be rearranged on the basis of an arbitrary item by operating a button b113, for example. In the case of the example shown in FIG. 11, the overviews of a buy order PO111, a buy order PO112, and the like are shown in the descending order of the paid remuneration amount on the screen S11.

In this manner, the display control unit 240 according to this embodiment is capable of displaying the search result of the buy order PO based on a skill condition S111 together with the supply-and-demand information SD111 and the like. With this configuration, the first user can check each piece of information displayed and then determine a reasonable desired remuneration amount at which a contract could be concluded. Further, the first user can register the sell order SO by inputting the determined desired remuneration amount in a field fill and pressing a button b112.

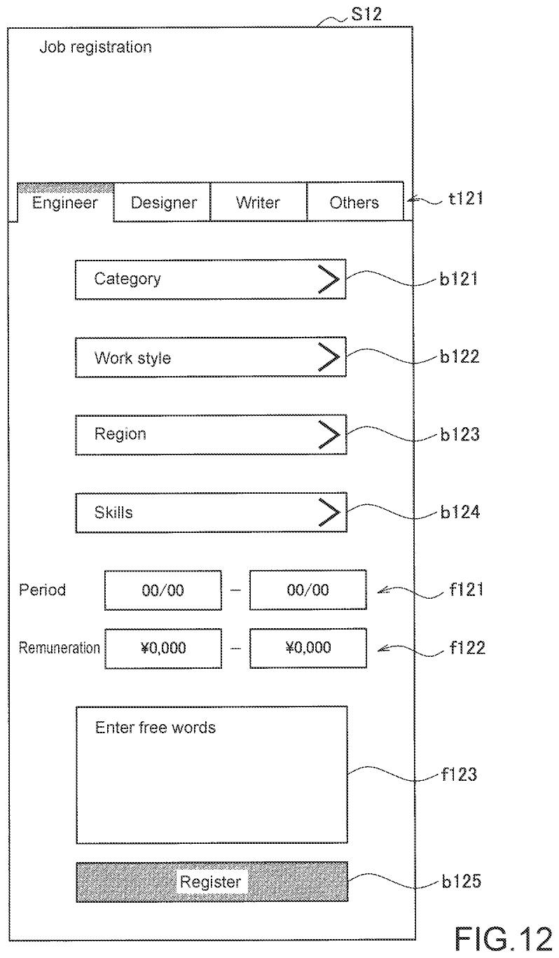

Next, registration of the buy order PO by the second user according to this embodiment will be described. FIG. 12 is a diagram showing an example of a registration screen of the buy order PO according to this embodiment. The second user according to this embodiment can register the buy order PO by inputting information regarding the desired skill set and the like and pressing a button b125 on a screen S12 shown in FIG. 12.

It should be noted that a tab t121, buttons b121 to b124, and fields f121 to f123 on the screen S12 may have functions equivalent to those of the tab t31, the buttons b32 to b35, and the fields f31 to f33 shown in FIG. 3, and thus detailed descriptions thereof are omitted.

Further, the second user according to this embodiment may be able to input the desired remuneration amount and register the buy order PO after checking the supply-and-demand information on the display screen of the search result shown in FIG. 11.

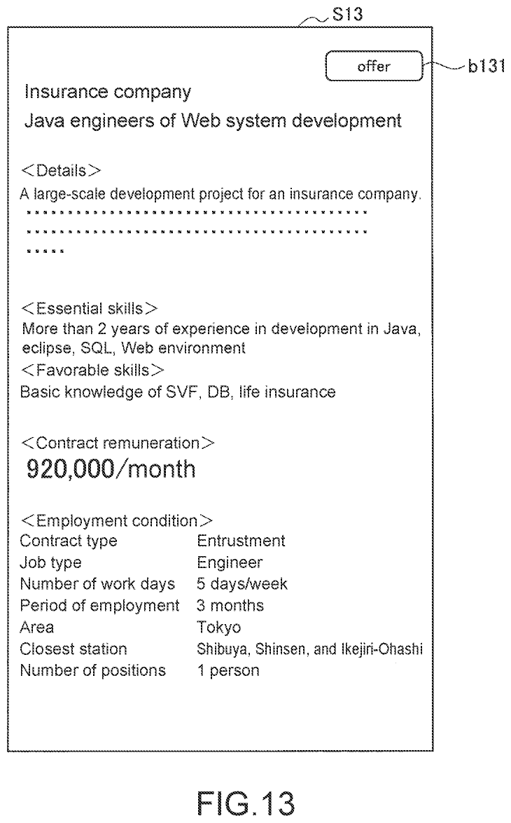

FIG. 13 is an example of a screen showing detailed information of the buy order PO registered as described above. In a screen S13 shown as an example in FIG. 13, the overview, details, essential skills, favorable skills, contract remuneration amount (paid remuneration amount), and employment conditions of the buy order PO are displayed on the basis of the contents input by the second user. Here, the above-mentioned essential skills may correspond to the desired skill information registered on the basis of the skills input by the second user on the screen S12 shown in FIG. 12. That is, the above-mentioned essential skills indicate the skill set used for matching with the sell order.

It should be noted that the first user according to this embodiment may be able to make a transition to the screen S13 by pressing each buy order PO shown in FIG. 1 or FIG. 11. Further, in a case where the first user checks the detailed information displayed on the screen S13 and determines that the detailed information matches the condition desired by the first user, the first user can negotiate a contract with the second user who has registered the buy order PO by pressing a button b131.

At this time, the display control unit 240 according to this embodiment may control a chat related to the contract negotiation between the first user and the second user on the basis of the requests of the first user or the second user by pressing of the button b131 arranged on the screen S13 or pressing of the button b71 arranged on the screen S7, for example. It should be noted that the chat according to this embodiment broadly includes a text chat, a video chat, and the like.

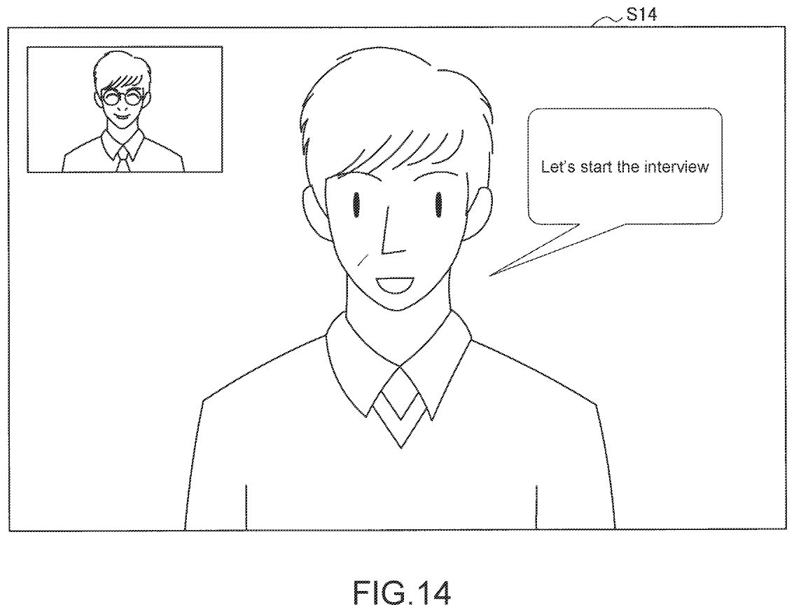

FIG. 14 is a diagram for describing chat control between the first user and the second user by the display control unit 240 according to this embodiment. In the case of the example shown in FIG. 14, the display control unit 240 starts a video chat for negotiating a contract between the first user and the second user in response to a request from the first user or the second user.

As described above, in accordance with the Web service realized by the information processing server 20 according to this embodiment, it is possible to immediately start the contract negotiation including an interview and the like on the basis of the request from the first user or the second user. With this configuration, it is possible to perform negotiation on a contract in a rapidly changing market without delay, and it is thus possible to enhance the advantage for both the users.

It should be noted that the first user and the second user may be able to set whether or not to accept a chat as described above in a manner that depends on the remuneration amount or the like. For example, the first user may be able to make a setting to accept a chat only from the second user who has set the paid remuneration amount equal to or higher than the desired paid remuneration amount set by the first user. Conversely, the second user is able to make a setting to accept a chat only from the first user that has set the desired remuneration amount equal to or lower than the set paid remuneration amount. The display control unit 240 according to this embodiment is capable of controlling whether or not to accept a chat between both the users on the basis of the settings as described above.

Further, the display control unit 240 according to this embodiment may control the display of the paid remuneration amount of the second user with which the first user is under contract negotiation and the display of the desired remuneration amount of the first user with which the second user is under contract negotiation in order to make the negotiation between both the users run smoothly.

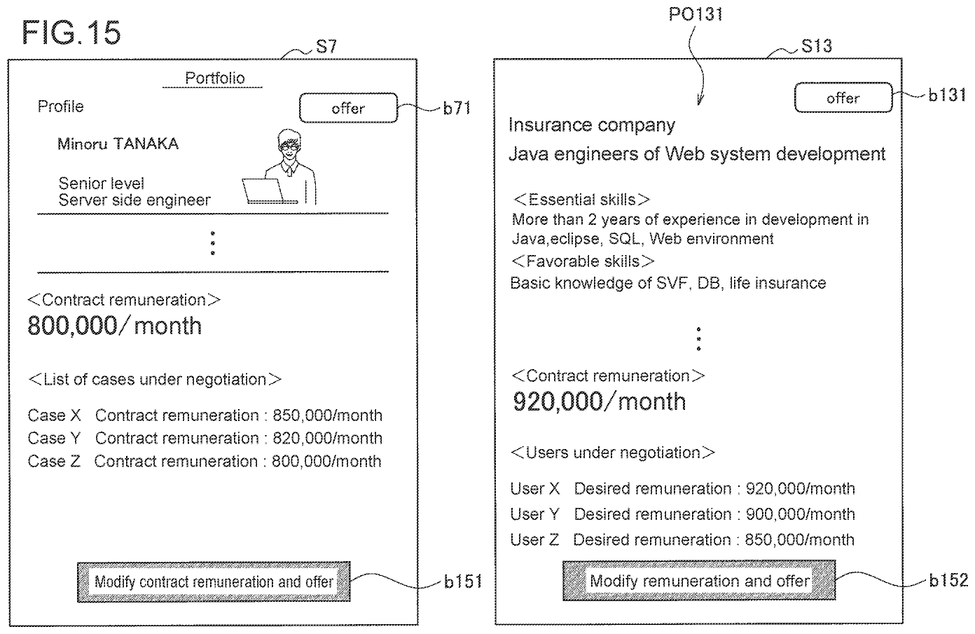

FIG. 15 is a diagram for describing the display of remuneration amounts relating to other users under contract negotiation according to this embodiment. The display control unit 240 according to this embodiment may display, for example, as shown on the left side in the figure, a list of cases (buy orders PO) in which the first user is under contract negotiation and contract remuneration (paid remuneration amounts) set for those cases on the screen S7 displaying the portfolio of the first user.

In accordance with such list display, the second user can negotiate with the first user after grasping the paid remuneration amounts set by other second users as competitors, and can increase the possibility of acquiring the first user. Further, at this time, the second user may be able to modify the paid remuneration amount related to the registered buy order PO by pressing a button b151 arranged on the screen S7, and to make a request for starting a chat.

Similarly, as shown on the right side of the figure, the display control unit 240 according to this embodiment may display a list of first users with which the second user who registered the buy order PO is under the negotiation and desired remuneration amounts set by the first users on the screen S13 displaying detailed information of the buy order PO.

In accordance with such list display, the first user can negotiate with the second user after grasping the desired remuneration amounts set by other first users as competitors, and can increase the possibility that the first user is employed. Further, at this time, the first user may be able to modify the desired remuneration amount related to the registered sell order SO by pressing a button b152 arranged on the screen S13, and to make a request for starting a chat.

In this manner, the display control unit 240 according to this embodiment can promote price competition between competitors by displaying the remuneration amounts set by the other users under contract negotiation, and can contribute to the optimization of the market price.

As described above, the functions of the information processing server 20 according to this embodiment have been described in detail. In accordance with the information processing server 20 according to this embodiment having the functions, it is possible to objectively indicate market prices of human resources and promote fair market competition. It should be noted that the above-mentioned functions and the like are merely examples, and the functions of the information processing server 20 according to this embodiment are not limited to these examples.

For example, in the above description, the case where the second user registers the buy order PO for each desired human resource has been described as an example, but the order information generating unit 220 according to this embodiment may automatically generate a plurality of pieces of buy order information specifying different skill sets on the basis of the desired skill information and the paid remuneration amount input by the second user.

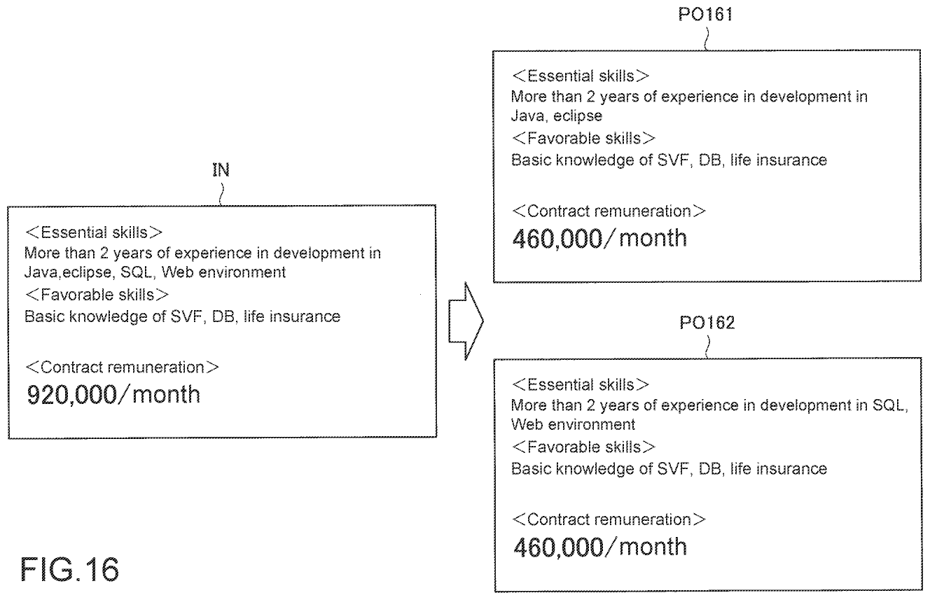

FIG. 16 is a diagram for describing the automatic generation of the plurality of pieces of buy order information by the order information generating unit 220 according to this embodiment. On the left side of FIG. 16, an example of input information IN including the desired skill information and the paid remuneration amount (contract remuneration) input by the second user is shown.

At this time, the order information generating unit 220 according to this embodiment may generate a plurality of pieces of buy order information by dividing the skill set and the paid remuneration amount corresponding to the input information IN, for example. On the right side of FIG. 16, a buy order PO161 and a buy order PO162 corresponding to the plurality of pieces of order information generated by the order information generating unit 220 are shown. It should be noted that at this time, the order information generating unit 220 is capable of performing the division such that the first user having a skill set after the division exists in the market in consideration of the registered possessed skill set of the first user.

The order information generating unit 220 according to this embodiment may perform such division processing on the basis of a request from the second user, for example. In this case, the second user can simultaneously register buy orders PO related to recruitment of a plurality of human resources necessary for accomplishing a project by inputting all skill sets necessary for the project and a total labor cost assumed for the project and instructing to perform division.

Further, the order information generating unit 220 according to this embodiment may suggest to the second user to divide the buy order PO into a plurality of buy orders PO by performing division as described above in a case where the first user who has the skill set corresponding to the desired skill information input by the second user does not exist in the market. In this case, the second user can grasp that the condition input by the second user does not match the market and can register the appropriate buy orders PO.

On the other hand, the buy order PO and the sell order SO according to this embodiment may designate a plurality of human resources. Such orders allow team-by-team recruitment and application to be made at the remuneration amount matching the market price.

«1.4. Flow of Processing»

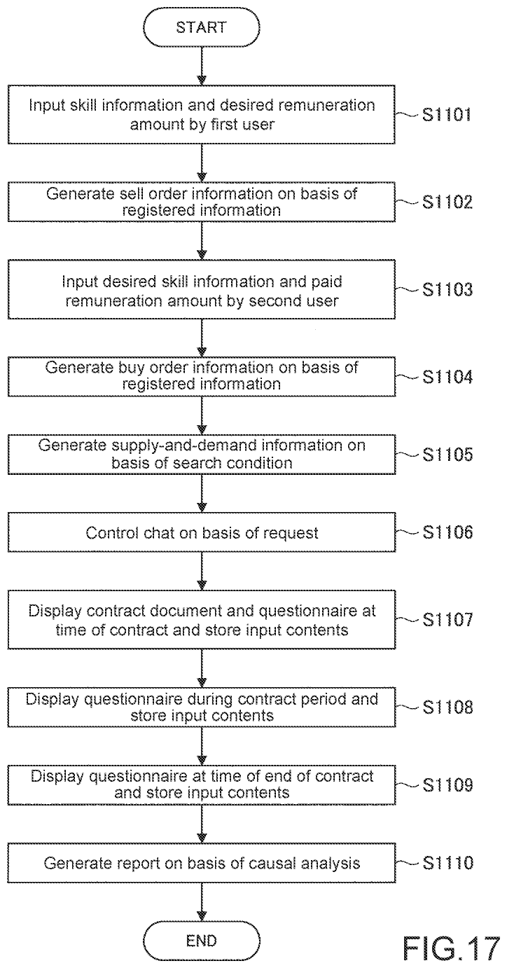

Next, a flow of processing of the information processing system according to this embodiment will be described in detail. FIG. 17 is a flowchart showing the flow of processing of the information processing system according to this embodiment. It should be noted that the flow of processing described below schematically shows the flow of each function and the like described above, and the information processing system according to this embodiment is capable of performing flexible processing in response to an operation by the first user or the second user.

Referring to FIG. 17, the first user first inputs skill information and a desired remuneration amount in the information processing terminal 10 (S1101). In this case, the registration unit 210 performs various types of information registration on the basis of the information received from the information processing terminal 10.

Next, the order information generating unit 220 according to this embodiment generates sell order information on the basis of the registered possessed skill information and desired remuneration amount (S1102).

Further, in parallel with Steps S1101 and S1102, in the information processing terminal 10, the second user inputs desired skill information and a paid remuneration amount (S1103). At this time, the registration unit 210 according to this embodiment performs various types of information registration on the basis of the information received from the information processing terminal 10.

Next, the order information generating unit 220 according to this embodiment generates buy order information on the basis of the registered desired skill information and paid remuneration amount (S1104).

Next, the supply-and-demand information generating unit 230 according to this embodiment dynamically generates supply-and-demand information for each skill set on the basis of an input search condition such as a skill set (S1105). Further, the display control unit 240 displays the supply-and-demand information generated by the supply-and-demand information generating unit 230 on the user interface as the search result.

Next, the display control unit 240 controls a chat related to a negotiation on the basis of a request from the first user or the second user (S1106).

When the contract between the first user and the second user is concluded, the display control unit 240 displays a contract document and a questionnaire at the time of contract on the user interface, and stores the input contents entered by both the users (S1107). The questionnaire at the time of contract may have the contents asking about the impression of the other partner at the time of contract, for example.

Further, also during the contract period, the display control unit 240 displays a questionnaire during the contract period on the user interface periodically or irregularly, and stores the input contents entered by both the users (S1108). The questionnaire during the contract period may be a questionnaire asking about a change in the impression of the other partner after the contract, whether or not the contents of the contract is observed, the work attitude of the first user, the suitability of commands of the second user, and the like, for example.

Further, when the contract ends, the display control unit 240 displays a questionnaire at the time of the end of the contract on the user interface and stores the input contents entered by both the users (S1109). The questionnaire at the time of the end of the contract may have the contents asking about the impression of the other partner at the time of the end of the contract.

Next, the analysis unit 250 according to this embodiment performs causal analysis for the first user and the second user on the basis of the contents of the questionnaires stored in Steps S1107 to S1109, and generates a report (S1110).

For example, the analysis unit 250 is capable of analyzing the relationship between the cause and the result of the start or end of the contract by the first user or the second user, and generating a report based on the analysis result. In accordance with such a report, it is possible for the first user or the second user who is engaged in negotiation of the contract to know the characteristics of the other party to thereby favorably proceed with the negotiation, to keep a good relationship after the contract, to reconsider the contract itself, and the like.

### 2. Hardware Configuration Example

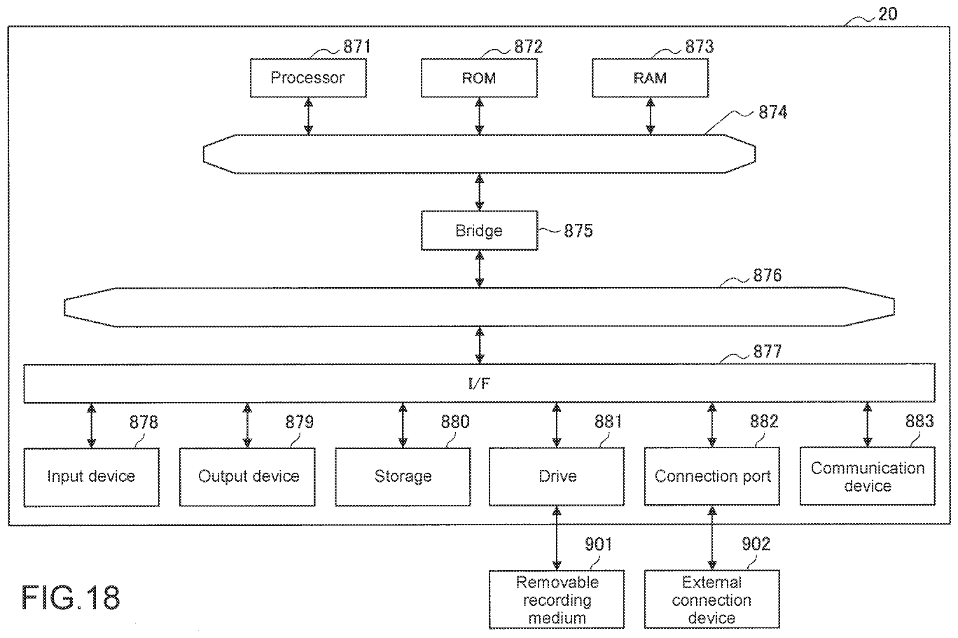

Next, a hardware configuration example of the information processing server 20 according to an embodiment of the present disclosure will be described. FIG. 18 is a block diagram showing an example of the hardware configuration of the information processing server 20 according to the embodiment of the present disclosure. As shown in FIG. 18, the information processing server 20 includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. It should be noted that the hardware configuration shown here is an example, and some of the components may be omitted. It may also further include components other than the components shown here.

(Processor 871)

The processor 871 functions, for example, as an arithmetic processing unit or a control unit and controls the overall operations of the respective components or some of them on the basis of various programs recorded on the ROM 872, the RAM 873, the storage 880, or a removable recording medium 901.

(ROM 872, RAM 873)

The ROM 872 is a means for storing programs read into the processor 871, data to be used in calculation, and the like. The RAM 873 temporarily or permanently stores, for example, programs read into the processor 871, various parameters that change as appropriate when the programs are executed, and the like.

(Host Bus 874, Bridge 875, External Bus 876, Interface 877)

The processor 871, the ROM 872, and the RAM 873 are connected to one another through the host bus 874 capable of high-speed data transmission, for example. On the other hand, the host bus 874 is connected to the external bus 876 having a relatively low data transmission speed via the bridge 875, for example. Further, the external bus 876 is connected to various components via the interface 877.

(Input Device 878)

For example, a mouse, a keyboard, a touch panel, a button, a switch, a lever, and the like are used as the input device 878. Further, a remote controller capable of transmitting a control signal using infrared rays and other radio waves may be used as the input device 878. Further, the input device 878 includes an audio input device such as a microphone.

(Output Device 879)

The output device 879 is a device capable of visually or audibly notifying a user of acquired information, for example, a display device such as a cathode ray tube (CRT), a LCD, and an organic EL, an audio output device such as a speaker and headphones, a printer, a mobile phone, a facsimile, or the like. Further, the output device 879 according to the present disclosure includes various vibration devices capable of outputting tactile stimuli.

(Storage 880)

The storage 880 is a device for storing various types of data. For example, a magnetic storage device such as a hard disk drive (HDD), a semiconductor storage device, an optical storage device, a magneto-optical storage device, or the like is used as the storage 880.

(Drive 881)

The drive 881 is, for example, a device that reads information recorded on the removable recording medium 901 such as a magnetic disk, an optical disc, a magneto-optical disk, and a semiconductor memory or writes information on the removable recording medium 901.

(Removable Recording Medium 901)

The removable recording medium 901 includes, for example, a DVD medium, a Blu-ray (registered trademark) medium, an HD DVD medium, various semiconductor storage media, or the like. The removable recording medium 901 may be, for example, an IC card on which a contactless IC chip is mounted, an electronic apparatus, or the like as a matter of course.

(Connection Port 882)

The connection port 882 is, for example, a port for connecting an external connection device 902 such as a universal serial bus (USB) port, an IEEE1394 port, a small computer system interface (SCSI), an RS-232C port, and an optical audio terminal.

(External Connection Device 902)

The external connection device 902 may be, for example, a printer, a portable music player, a digital camera, a digital video camera, an IC recorder, or the like.

(Communication Device 883)

The communication device 883 is a communication device for connecting to a network and includes, for example, a wired or wireless LAN, Bluetooth (registered trademark), a communication card for a Wireless USB (WUSB), a router for optical communication, a router for an asymmetric digital subscriber line (ADSL), modems for various types of communication, and the like.

### 3. Conclusion

As described above, the information processing server 20 according to the embodiment of the present disclosure includes the supply-and-demand information generating unit 230 that generates the supply-and-demand information indicating the supply and demand of the first user who desires provision of the human resource and the second user who desires provision of the remuneration as the price for the provision of the human resource. Further, the supply-and-demand information generating unit 230 according to the embodiment of the present disclosure is characterized by generating the supply-and-demand information for each skill set that matches between the possessed skill information of the first user and the desired skill information of the second user. With this configuration, it is possible to objectively indicate market prices of human resources and promote fair market competition.

While the favorable embodiments of the present disclosure have been described in detail with reference to the accompanying drawings, the technical scope of the present disclosure is not limited to those examples. It is obvious that various changes or modifications may be conceived by a person having ordinary knowledge in the art of the present disclosure within the scope of the technical ideas defined in the scope of claims, and it is understood that these also fall within the technical scope of the present disclosure as a matter of course.

In addition, the effects described in the present specification are illustrative or exemplary only and not restrictive. In other words, the technology according to the present disclosure may have other effects apparent to those skilled in the art in light of the description of the present specification together with the above-mentioned effects or in place of the above-mentioned effects.

Further, a program for performing functions equivalent to those of the configurations of the information processing server 20 can also be generated in hardware such as a CPU, a ROM, and a RAM built in a computer and a non-transitory computer readable medium in which the program is recorded can also be provided.

Further, the respective steps associated with the processing of the information processing system in the present specification does not necessarily have to be processed in time series along the order described in the flowchart. For example, the respective steps associated with the processing of the information processing system may be processed in an order different from the order described in the flowcharts or may be processed in parallel.

It should be noted that the following configurations also fall within the technical scope of the present disclosure.
(1) An information processing apparatus, including:

a supply-and-demand information generating unit that generates supply-and-demand information indicating supply and demand of a first user who desires provision of a human resource and a second user who desires provision of remuneration as price for the provision of the human resource, in which

the supply-and-demand information generating unit generates the supply-and-demand information for each skill set between possessed skill information of the first user and desired skill information of the second user.
(2) The information processing apparatus according to (1), in which

the supply-and-demand information generating unit generates the supply-and-demand information also on the basis of a desired remuneration amount input by the first user and a paid remuneration amount input by the second user.
(3) The information processing apparatus according to (2), in which

the supply-and-demand information generating unit generates the supply-and-demand information including a distribution of the desired remuneration amount and the paid remuneration amount for each skill set.
(4) The information processing apparatus according to (2) or (3), further including

an order information generating unit that generates sell order information associated with the provision of the human resource and buy order information associated with the provision of the remuneration, in which

the order information generating unit generates the sell order information on the basis of the possessed skill information of the first user and the desired remuneration amount and generates the buy order information on the basis of the desired skill information of the second user and the paid remuneration amount, and

the supply-and-demand information generating unit generates the supply-and-demand information including a distribution of the sell order information and the buy order information for each skill set.
(5) The information processing apparatus according to (4), further including

a display control unit that controls display of the supply-and-demand information.
(6) The information processing apparatus according to (5), in which

the display control unit causes the supply-and-demand information to be displayed using a board representation.
(7) The information processing apparatus according to (5) or (6), in which

the display control unit controls display of remuneration quotation information based on the supply-and-demand information.
(8) The information processing apparatus according to (7), in which

the display control unit causes the remuneration quotation information in a case where the first user acquires a further skill to be displayed.
(9) The information processing apparatus according to any of (5) to (8), in which

the display control unit causes a transition of the supply and demand associated with the first user and the second user on the basis of the supply-and-demand information to be displayed in time series for each skill set.
(10) The information processing apparatus according to any of (5) to (9), in which

the display control unit causes a prediction of the supply and demand associated with the first user and the second user, which is based on the supply-and-demand information, to be displayed for each skill set.
(11) The information processing apparatus according to any of (5) to (10), in which

the display control unit controls a chat related to a contract negotiation between the first user and the second user on the basis of a request from the first user or the second user.
(12) The information processing apparatus according to any of (5) to (11), in which

the display control unit controls display of past contract conclusion information associated with the first user.
(13) The information processing apparatus according to (12), in which

the contract conclusion information includes contract remuneration amount information and remuneration quotation information at a contract time.
(14) The information processing apparatus according to any of (5) to (13), in which

the display control unit controls display of the paid remuneration amount of the second user with which the first user is under negotiation on the contract or the desired remuneration amount of the first user with which the second user is under negotiation on the contract.
(15) The information processing apparatus according to any of (4) to (14), in which

the order information generating unit generates a plurality of pieces of buy order information specifying different skill sets on the basis of the desired skill information and the paid remuneration amount input by the second user.
(16) The information processing apparatus according to any of (1) to (15), further including

a registration unit that automatically generates the possessed skill information associated with the first user on the basis of content uploaded by the first user.
(17) An information processing method, including

generating, by a processor, supply-and-demand information indicating supply and demand of a first user who desires provision of a human resource and a second user who desires provision of remuneration as price for the provision of the human resource, in which

the generating the supply-and-demand information includes generating the supply-and-demand information for each skill set between possessed skill information of the first user and desired skill information of the second user.
(18) A program that causes a computer to function as an information processing apparatus including

a supply-and-demand information generating unit that generates supply-and-demand information indicating supply and demand of a first user who desires provision of a human resource and a second user who desires provision of remuneration as price for the provision of the human resource, in which

the supply-and-demand information generating unit generates the supply-and-demand information for each skill set between possessed skill information of the first user and desired skill information of the second user.

### reference signs list

10 information processing terminal
20 information processing server
210 registration unit
220 order information generating unit
230 supply-and-demand information generating unit
240 display control unit
250 analysis unit
260 communication unit

1. An information processing apparatus, comprising:
a supply-and-demand information generating unit that generates supply-and-demand information indicating supply and demand of a first user who desires provision of a human resource and a second user who desires provision of remuneration as price for the provision of the human resource, wherein
the supply-and-demand information generating unit generates the supply-and-demand information for each skill set between possessed skill information of the first user and desired skill information of the second user.

2. The information processing apparatus according to claim 1, wherein
the supply-and-demand information generating unit generates the supply-and-demand information also on a basis of a desired remuneration amount input by the first user and a paid remuneration amount input by the second user.

3. The information processing apparatus according to claim 2, wherein
the supply-and-demand information generating unit generates the supply-and-demand information including a distribution of the desired remuneration amount and the paid remuneration amount for each skill set.

4. The information processing apparatus according to claim 2, further comprising
an order information generating unit that generates sell order information associated with the provision of the human resource and buy order information associated with the provision of the remuneration, wherein
the order information generating unit generates the sell order information on a basis of the possessed skill information of the first user and the desired remuneration amount and generates the buy order information on a basis of the desired skill information of the second user and the paid remuneration amount, and
the supply-and-demand information generating unit generates the supply-and-demand information including a distribution of the sell order information and the buy order information for each skill set.

5. The information processing apparatus according to claim 4, further comprising
a display control unit that controls display of the supply-and-demand information.

6. The information processing apparatus according to claim 5, wherein
the display control unit causes the supply-and-demand information to be displayed using a board representation.

7. The information processing apparatus according to claim 5, wherein
the display control unit controls display of remuneration quotation information based on the supply-and-demand information.

8. The information processing apparatus according to claim 7, wherein
the display control unit causes the remuneration quotation information in a case where the first user acquires a further skill to be displayed.

9. The information processing apparatus according to claim 5, wherein
the display control unit causes a transition of the supply and demand associated with the first user and the second user on a basis of the supply-and-demand information to be displayed in time series for each skill set.

10. The information processing apparatus according to claim 5, wherein
the display control unit causes a prediction of the supply and demand associated with the first user and the second user, which is based on the supply-and-demand information, to be displayed for each skill set.

11. The information processing apparatus according to claim 5, wherein
the display control unit controls a chat related to a contract negotiation between the first user and the second user on a basis of a request from the first user or the second user.

12. The information processing apparatus according to claim 5, wherein
the display control unit controls display of past contract conclusion information associated with the first user.

13. The information processing apparatus according to claim 12, wherein
the contract conclusion information includes contract remuneration amount information and remuneration quotation information at a contract time.

14. The information processing apparatus according to claim 5, wherein
the display control unit controls display of the paid remuneration amount of the second user with which the first user is under negotiation on the contract or the desired remuneration amount of the first user with which the second user is under negotiation on the contract.

15. The information processing apparatus according to claim 4, wherein
the order information generating unit generates a plurality of pieces of buy order information specifying different skill sets on a basis of the desired skill information and the paid remuneration amount input by the second user.

16. The information processing apparatus according to claim 1, further comprising
a registration unit that automatically generates the possessed skill information associated with the first user on a basis of content uploaded by the first user.

17. An information processing method, comprising
generating, by a processor, supply-and-demand information indicating supply and demand of a first user who desires provision of a human resource and a second user who desires provision of remuneration as price for the provision of the human resource, wherein
the generating the supply-and-demand information includes generating the supply-and-demand information for each skill set between possessed skill information of the first user and desired skill information of the second user.

18. A program that causes a computer to function as an information processing apparatus including
a supply-and-demand information generating unit that generates supply-and-demand information indicating supply and demand of a first user who desires provision of a human resource and a second user who desires provision of remuneration as price for the provision of the human resource, wherein
the supply-and-demand information generating unit generates the supply-and-demand information for each skill set between possessed skill information of the first user and desired skill information of the second user.
